(19) United States
(12) Patent Application Publication
(10) Pub. No.: US 2010/0315678 A1
(43) Pub. Date: Dec. 16, 2010

(54) Method and apparatus of wirelessly connecting a first device to a second device

(76) Inventors: Thami Smires, Parlin, NJ (US); Chris Powell, Metuchen, NJ (US); Allen Luo, Franklin Park, NJ (US)

Correspondence Address: Welsh Flaxman & Gitler, 2000 Duke Street , Suite 100, Alexandria, VA, 22314, US

(21) Appl. No.: 12/801,587

(22) Filed: Jun. 16, 2010

Related U.S. Application Data
(60) Provisional application No. 61/213,514, filed on Jun. 16, 2009.

(51) Int. Cl. H04B 7/24; G06Q 20/00; G07G 5/00; H04B 7/00; G06F 15/00; H04B 5/00

(52) U.S. Cl. 358/1.15; 235/380; 455/39; 455/41.2; 455/41.1

(57) ABSTRACT

A system and method for wirelessly connecting a first device to a second device utilizing a contactless smart card or RFID tag provided in proximity with the first device, the smart card or RFID tag containing information allowing the first device to be connected to the second device for the purpose of establishing a one way or two way connection between the two devices. The system and method of the present invention also allows information contained in a credit/debit card to be wirelessly transferred into the first device, either directly or indirectly, through the second device.

### RELATED APPLICATIONS

The present application claims the priority of U.S. Provisional Patent Application Ser. No. 61/213,514, filed on Jun. 16, 2010.

### FIELD OF THE INVENTION

The present invention is directed to a method and system for utilizing near field communication (NFC) Bluetooth technology to provide two way communication between a first device and a second device. The material provided between the first and second devices can be, but need not be, limited to transactional data files or images. Combined with the ability to transmit wirelessly the transactional data, files or images collected in the two way communication NFC/Bluetooth process to gateway/servers result in real time Internet based reporting and as well as providing a consolidated back end platform for data management.

### BACKGROUND OF THE INVENTION

There is no doubt that we are living in a wireless age. In years past, if various electrical or electronic devices were to communicate with one another, this could only be accomplished utilizing unwieldy wired connections. However, in recent years, this requirement of a wire connection between the devices has lessened. At the present time, functions of various devices, such as portable terminals, embodied in, for example, cellular telephones, personal digital assistance (PDAs) netbook/notebook computers, and RFID tags, have been advancing. Many of these portable terminals have recently been provided with radio data communication functions, some of which now employ near field radio communication interfaces used in technologies for non-contact integrated circuit (IC) cards to be associated with these portable terminals. Utilizing near field radio communication interfaces in portable terminals provides the portable terminals with functions similar to those of non-contact IC cards. However, the issue of pairing or connectivity between portable terminals have always been difficult to maintain.

### SUMMARY OF THE INVENTION

The deficiencies of the prior art are addressed by the present invention which establishes near field/Bluetooth one way or two way communication between a first device and a second device. Although the teachings of the present invention can be used to establish communication between any electronic devices, for ease of explanation, the present invention will be described with respect to communication between a portable telephone and a Bluetooth enabled printer/magnetic card swiper device. Additionally, although various applications could be used between these devices, for ease of explanation, the present invention will be described utilizing an application to complete point of sale transactions generally consummated at, but not limited to, a commercial establishment. In this application, a wireless communication is established between a telephone, a wireless network and a gateway in communication with a bank or other commercial establishment for approving or disallowing a credit card or debit card transaction. Additionally, although any NFC enabled mobile telephone can be used to establish the connection between the software application and gateway and the Bluetooth enabled printer, it has been found that Nokia telephone models 6131 and 6212 are particularly adapted to streamline the NFC technology and combined with the Charge Anywhere® software allows establishment and reestablishment of Bluetooth connectivity between the first and second devices.

A passive radio frequency identification (RFID) smart card/tag is provided with a chip having the specific Bluetooth device's pairing information stored on it in a format allowing it to be transmitted and received by the telephone using non-contact transfer of information. For the purpose of the present invention, it is noted that the term “telephone” will refer to any device having the capability to wirelessly transmit and receive both verbal and non-verbal information. A software application is provided in the memory of the telephone to receive this information which would include the Bluetooth address of the second device, in this instance a printer/swiper as well as the passcode used to do the initial pairing between the telephone and the printer/swiper. The pairing information is provided to the telephone by bringing a smart card/tag having this information in its memory in proximity with the telephone when the application is closed. Once the information has been transferred to the telephone, it will remain in the telephone's memory. Connectivity is then established between the telephone and the printer/swiper by opening the software application and putting the smart card/tag in proximity to the telephone a second time. Once a wireless communication is established between the telephone and the printer/magnetic card swiper, credit or debit card information entered into the system by swiping the credit or debit card through the printer/magnetic card swiper would be wirelessly transmitted to the telephone.

A commercial transaction can be consummated between a merchant and a customer. For example, a dollar amount of a particular transaction is then entered into the telephone using various input mechanisms, such as, but not limited to, a standard keypad, or similar device. The telephone would then automatically establish a wireless communication with a wireless network which enables Internet connectivity to a gateway, which in turn would establish a communication with an entity, such as a bank or credit card company to determine whether the transaction would be approved or denied. Response information from the bank or credit card company is then collected at the gateway and then securely transmitted back to the software application residing on the telephone. If the transaction was approved, this information will be automatically relayed from the telephone to the printer/swiper. The printer/swiper would print paper copies of the transaction, one of which will be given to the customer and the other one retained by the merchant. A second manner of transferring credit or debit card information to the telephone would be by using a passive RFID chip in the credit or debit card which would wirelessly transfer this information to the telephone. Regardless of the manner in which the credit or debit card information is entered into the system, this information would be stored in a memory portion of the software application provided in the telephone along with information relating to the transaction, such as the amount, and whether the transaction was approved or denied.

### BRIEF DESCRIPTION OF THE DRAWINGS

The above and other objects, features, aspects and advantages of the present invention will become more apparent from the following detailed description of the present invention when taken in conjunction with the accompanying drawings.

FIG. 1 is a block diagram showing the components of the present invention;

FIG. 2 is a flow diagram showing the manner in which a Bluetooth pairing is established; and

FIG. 3 is a flow diagram showing the manner in which contactless communication is established between a telephone and a credit or debit card.

### DETAILED DESCRIPTION OF THE PRESENT INVENTION

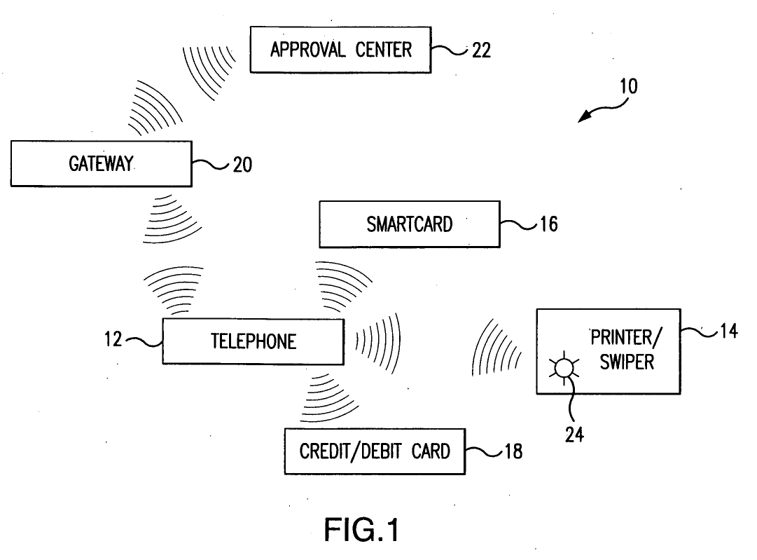

FIG. 1 is a block diagram 10 showing the major components of the present invention used to conduct and consummate a commercial transaction. In this instance, a mobile telephone 12, such as a Nokia 6131, 6212 or any other NFC enabled mobile telephone would be used to obtain approval or denial of the commercial transaction. The telephone 12 is to be in wireless communication using an NFC/Bluetooth technology with another device, such as a printer/magnetic card swiper 14. Pairing or connectivity is established between the telephone 12 and the printer/magnetic card swiper 14 using a passive contactless RFID smart card/tag 16 in conjunction with a software operating system having an application to establish communication between the telephone 12 and the printer/magnetic card swiper 14. The smart card/tag 16 is provided with a chip therein containing the Bluetooth address of the printer/magnetic card swiper 14 as well as a passcode used to do the initial pairing between the telephone 12 and the printer/magnetic card swiper 14. As can be appreciated, different smart cards/tags could be used to connect the telephone 12, or any other first device to any second device. These particular RFID smart cards/tags would of course include the appropriate Bluetooth address and the passcode used to do the initial pairing between any first devices to any second device. However, for ease of understanding, the explanation of the present invention would utilize a connector between a mobile telephone and a printer/magnetic card swiper. It is important to note that the RFID smart card/tag 16 is associated with only a single second device, such as the printer/magnetic card swiper 14. Connection between the telephone 12 and other second devices or other printers must be established using separate RFID card/tags for each of the second devices.

The pairing would be established by bringing the card/tag (or telephone to the tag) 16 in proximity to the telephone 12 when the application is closed. This initial passage of the smart card/tag 14 in proximity does not initiate communications between the telephone 12 and the printer/magnetic card swiper 14, but allows the Bluetooth address and the pass code to be stored in the memory of the telephone 12. Connectivity of the telephone 12 with the printer/magnetic card swiper 14 is established by bringing the smart card/tag 16 in proximity with the telephone 12 a second time when the application is opened. This can be accomplished by providing a screen associated with the telephone 12, allowing various applications to be scrolled, until the software application is opened. It is important to note that once connectivity has been initially established between the telephone 12 and the printer/magnetic card swiper 14, and then terminated, the Bluetooth address and pass code of the printer/magnetic card 14 would permanently remain in the memory of the telephone 12 connection between the telephone 12 and the printer magnetic card 14 would be re-established by a single pass of the smart card/tag 16 in proximity with the telephone 12.

Once connectivity is established, an indicator 24 provided on the printer/magnetic swiper 14 would illuminate or blink. Alternatively, any other type of indicator associated with the printer/magnetic swiper 14 could be used to positively indicate that the connection has been established between the telephone 12 and the printer/magnetic card swiper 14. Additionally, the illumination/indicator device 24 would indicate when the communication between the telephone 12 and the printer/magnetic card swiper 14 has terminated. For example, if the illumination of the indicator 24 indicates that communication has been established, the cessation of illumination of the indicator 24 would mean that the connection between the telephone 12 and the printer/magnetic swiper 14 has ended.

At some point, after communication between the telephone 12 and the printer/magnetic card swiper 14 has been established, a standard credit/debit card would be swiped in the printer/magnetic card swiper 14, thereby transmitting the information contained on the card, such as the card number, name of the user, expiration date as well as any other relevant information to the software application residing on the telephone 12. This information would be stored in the secure software application residing in the memory of the telephone 12 and would remain therein regardless of whether the pairing between the telephone 12 and the printer/magnetic card swiper 14 has been terminated.

At this point, the telephone keypad or any other input device associated with the telephone 12 is used to enter the amount of a commercial transaction. The appropriate information contained on the credit/debit card is then transmitted, along with the amount of the transaction to a gateway 20 which is in communication with an approval center 22. Once it is determined that the transaction was approved, an approval number would be transmitted from the approval center 22 through the gateway 20 and then to the telephone 12. A screen associated with the telephone 12 would then display the approval number as well as other relevant information transferred from the credit/debit card. Since there is pairing between the telephone 12 and the printer 14, the appropriate transaction slip or slips would be automatically printed after the receipt of the approval number by the telephone 12 and this information wirelessly transmitted between the telephone 12 and the printer 14. The communication between the telephone 12, the gateway 20 and the approval center 22 is generally wireless in nature.

The present invention contemplates an alternative method of consummating the commercial transaction by utilizing an RFID credit/debit card 18. Similar to the smart card/tag 16, the credit/debit card 18 is passive in nature and once it is in proximity with the telephone 12, information contained in a chip provided on the credit/debit card 18 would be transmitted to the software application and retained in the telephone 12. Both the smart card/tag 16 and the credit/debit card 18 would obtain the power for transmitting the information contained therein directly from the telephone 12. Similar to the embodiment described when a standard credit/debit card is swiped by the printer/magnetic card swiper 14, after the information provided on the RFID credit/debit card 18 is transferred to the memory unit of software provided within the telephone 12, a merchant can enter the transaction amount and send the credit/debit card information along with the transaction amount to the approval center 22 through the gateway 20. Upon receipt of an approval of the transaction by the telephone 12, the printer/magnetic card swiper 14 would automatically print the appropriate transaction information on a first copy to be retained by the merchant as well as a second copy to be given or alternatively emailed to the customer. In this scenario, establishment of communication between the telephone 12 and the printer/magnetic card swiper 14 through the use of the smart card/tag 16 in possession of the merchant can be accomplished before or after communication is established between the telephone 12 and the RFID credit/debit card 18, as well as after the transaction information is sent by the telephone 12 to the gateway 26.

The particular embodiment of the present invention would require the use of various applications and software. For example, if a Nokia telephone were employed, this phone would be provided with software such as JSR-139 which is a connected, limited device configuration software, JSR-118 containing a profile of the telephone, JSR-82 which is a JAVA APIs a Bluetooth device as well as JSR-257 which is used to recognize the smart card 16 and the RFID credit/debit card 18. However, it can be appreciated that if other mobile telephones are employed, or for that matter any device which is designed to be wirelessly connected through NFC Bluetooth technology to a second device, different software would be employed. Additionally, it is noted that for the purpose of consummating a customer transaction, CHARGE Anywhere® payment application would be employed.

The method of using the present invention will now be explained. In a first application, each user of the system would be provided with the passive RFID smart card/tag 16 having the Bluetooth address of the particular device, such as the printer/magnetic card swiper 14 to which a two way communication with the telephone 12 is to be established between the two devices. Other passive RFID smart cards/tags would be used to establish paring and communication between the telephone 12 and other devices. In another application, a one way communication would be established between the two devices in which information will be transmitted from the telephone 12 to the printer/magnetic card swiper 14, but not vice versa. In both applications, the smart card/tag 16 is initially placed in close proximity with the telephone 12. In the application in which a two way communication is established, the first step of the process would be to put the smart card/tag 16 in proximity with the telephone 12. Since the smart card/tag 16 is a contactless card, there is no requirement that it must physically touch the telephone 12. The telephone 12 would produce a signal received by the smart card/tag 16 to both power the smart card/tag 16 as well as to allow it to transmit the Bluetooth address and passcode of the printer to be permanently stored in an appropriate location in the memory unit of the software provided in the telephone 12 by initially passing the passive RFID smart card in proximity with the telephone 12 with the application software closed. An application to be used in the process, such as the CHARGE Anywhere® application is opened using the keypad or scrolling device on the telephone prior to the smart card/tag 16 being in proximity with the telephone 12. Subsequently, the smart card 16 is again moved to be in proximity with the telephone 12 to establish communication with the printer/magnetic swiper 14. At this point, an appropriate signal is transmitted between the telephone 12 and the printer/magnetic card swiper 14 thereby wirelessly connecting the two devices together. When this occurs, an indicator, such as a light or lamp 24 will be illuminated. At this point, a standard credit or debit card can be swiped through the printer/swiper 14. The relevant information contained thereon would be wirelessly transmitted to the telephone 12 and stored therein. A transaction amount is entered on the keypad of the telephone 12 and this information along with the information on the credit card is wirelessly transmitted through the gateway 20 to the approval center 22. Once the transaction has been approved, an approval code is wirelessly transmitted to the telephone 12 through gateway 20. The printer/magnetic card swiper 14 would automatically produce the appropriate copies, after wirelessly being contacted by the telephone 12.

It is noted that all of the communications between the telephone 12, the printer/magnetic card swiper 14 as well as any other device in the system would be securely encoded.

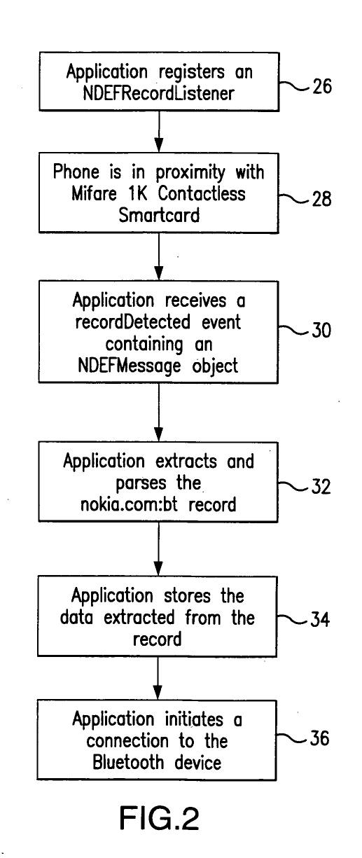

The technical aspect of the Bluetooth pairing between the telephone 12 and the printer/swiper 14 is shown in FIG. 2. When the smart car/tag 16 is in proximity with the telephone 12, the smart card/tag 16 would transmit a signal to the telephone 12 containing the Bluetooth address and pass code associated with the printer/magnetic swiper 14. This information will be stored in the memory of the telephone 12 and will be subsequently used to connect the telephone 12 with the printer/magnetic swiper 14. When a connection is to be established, the application provided on the telephone is opened and the smart card/tag 16 is again brought into proximity with the telephone 12 at Step 28. The application would then receive a recordDetected event containing an NDEFMessage object at Step 30. The method, at Step 32, would extract the appropriate material from the smart card 16. This material is stored at Step 34 and then the application would initiate the connection with the Bluetooth device, such as the printer/magnetic card swiper 14, at Step 36. During Step 32, if an appropriate record is found, the data portion of this record is parsed to extract the Bluetooth device's address and name which is stored in the application settings. Although the method according to the present invention is described in the manner requiring that the smart card 16 be provided in proximity with the telephone 12 on two occasions prior to the pairing, it is noted that based upon the software included in the telephone 12, it is possible that the smart card 16 must be in proximity with the telephone 12 only on a single occasion. Once wireless communication is established between the telephone 12 and the printer/magnetic swiper 14, the credit or debit card can then be swiped, the information contained on the magnetic strip of the credit or debit card would be wirelessly transmitted to the telephone 12 and stored therein for later use.

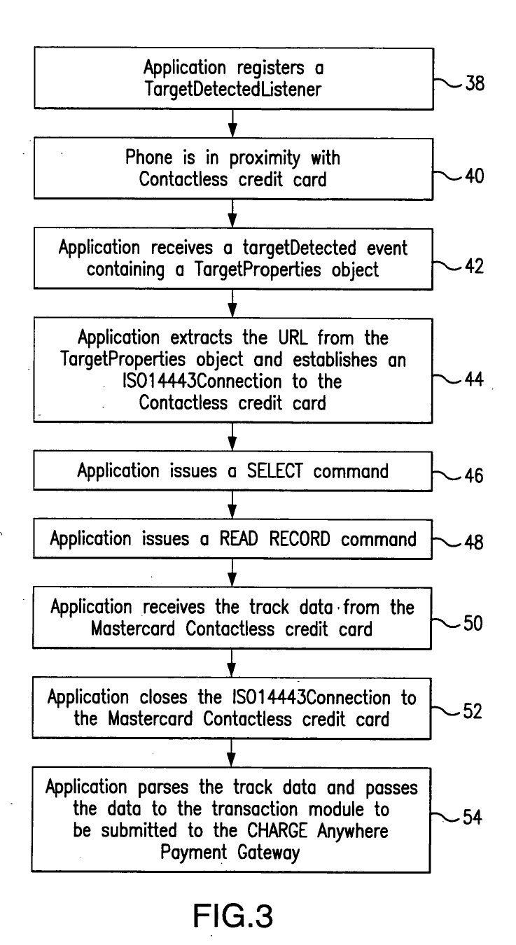

The present invention is designed to allow a credit/debit card to be read by the telephone 12 by establishing an ISO 14443 Type B connection using ISO 7816-4 commands. In this instance, when the particular application, such as the CHARGE Anywhere® software is opened, and the passive RFID credit/debit card 18 is in proximity with the telephone 12, the application would receive a targetDetected event after the software registers a targetDetected listener at Steps 38, 40 and 42, as illustrated in FIG. 3. The targetDetected event would contain a targetProperties object at Step 42. The application at Step 44 would extract the URL from the targetProperties object and establishing the ISO 14443 Type B connection to the contactless credit/debit card. This connection can be established before or after the smart card 16 is in proximity with the telephone 12, as long as the application within the telephone 12 can be manually initiated. This would allow connection between the credit/debit card 18 and the application on the mobile phone 12. At Step 46, the application would send an ISO 7816-4 SELECT COMMAND to activate the credit card applet located on the credit card. The software, at Step 48, provides a read record COMMAND to retrieve the appropriate data from the credit/debit card. After the data is retrieved at Step 50, the connection between the credit/debit card 18 and the mobile telephone 12 is closed at Step 52. The tracked data is then parsed and presented in a manner that can be submitted to a gateway, such as the CHARGE Anywhere® ComsGate payment gateway to approve a transaction.

It will be seen that some changes can be made from the description of the present invention without departing from the spirit and scope of the invention. For example, the present invention can be used to capture critical health data from medical devices attached to or embedded into patrons, such as traditional insulin pumps, pacemakers, camera pills, etc. In this situation, when the patient is in proximity with a device, such as a mobile telephone, and a connection is made between the two, the appropriate information would be extracted by the telephone and stored and/or transmitted to a central facility for processing. The same technology can be applied to capture information stored on various electronic instruments, moving vehicles, homes, buildings and the like. The only requirement in this situation would be that the device to which this information would be in proximity with the instruments storing the information. All these applications would be in combination with gateway data services and real time web based access to the data. Consequently, it is intended that all matter contained in the above description and shown in the accompanying drawings shall be interpreted as illustrative and not in a limiting sense.

What is claimed is:

1. A system for establishing wireless connection between a first device and a second device, comprising:
a software application and memory provided in the first device;
a smart card/tag device having a memory provided with the address of the second device, said smart card/tag having means for wirelessly transferring the address of the second device to said software application and memory provided in the first device.

2. The system in accordance with claim 1, wherein said smart card/tag device contains a passcode transmitted to the first device used to establish a wireless connection between the first and second devices, said address is a Bluetooth address.

3. The system in accordance with claim 2, wherein the first device is a mobile telephone and the second device is a printer.

4. The system in accordance with claim 3, further when said printer is provided with a device for reading information provided on a magnetic strip.

5. The system in accordance with claim 4, wherein said printer is provided with a means for wirelessly transmitting said information provided on a magnetic strip to said mobile telephone.

6. The system in accordance with claim 3, wherein said mobile telephone is provided with a means for wirelessly reading information provided in a memory included on a credit/debit card.

7. The system in accordance with claim 5, wherein said mobile telephone is provided with an input device for entering information, such as a transaction amount, into said mobile telephone and a display.

8. The system in accordance with claim 6, wherein said mobile telephone is provided with an input device for entering information, such as a transaction amount, into said mobile telephone and a display.

9. The system in accordance with claim 3, wherein said printer is provided with an indicator showing that said wireless connection between said mobile telephone and said printer has been established.

10. The system in accordance with claim 8, wherein said mobile telephone is provided with a means to wirelessly transmit said transaction amount and said information provided in a memory included on a credit/debit card to a central facility for approving or denying a transaction, said mobile telephone further including a means for receiving a wireless transmission from the central facility approving or denying the transaction.

11. The system in accordance with claim 10, wherein said printer is provided with a means for printing a sales slip when the transaction has been approved.

12. The system in accordance with claim 7, wherein said mobile telephone is provided with a means to wirelessly transmit said transaction amount and said information provided in the magnetic strip to a central facility for approving or denying a transaction, said mobile telephone further including a means for receiving a wireless transmission from the central facility approving or denying the transaction.

13. The system in accordance with claim 12, wherein said printer is provided with a means for printing a sales slip when the transaction has been approved.

14. A method for establishing a near field wireless communication between a first device having a software application and memory, and a second device, comprising the steps of:
placing a smart card/tag device having a memory provided with the address and passcode of the second device in proximity with the first device;
wirelessly transmitting said address and said passcode from said smart card/tag to the memory of the first device; and
wirelessly transmitting said address and said passcode from the first device to the second device, thereby establishing a wireless connection between the first device and the second device.

15. The method in accordance with claim 14, wherein the first device is a mobile telephone and the second device is a printer, further including the step of:
wirelessly transmitting information included in a memory of a credit/debit card directly to the memory of said mobile telephone.

16. The method in accordance with claim 15, wherein said mobile telephone includes an input device, further including the steps of:
inputting a transaction amount from the input device into the memory of said mobile telephone;
wirelessly transmitting said transaction amount and said information included in the memory of the credit/debit card to a central facility to determine whether a transaction has been approved or denied;
receiving in said mobile telephone a decision as to the approval or denial of said transaction;
wirelessly transmitting from said mobile telephone to said printer the approval of said transaction; and
printing a sales slip from said printing of said transaction.

17. The method in accordance with claim 15, wherein said printer is provided with a magnetic swipe device, further including the steps of:
swiping a credit/debit card though said magnetic swipe device for eliciting information provided the memory of said credit/debit card;
wirelessly transmitting said information provided on the memory of said credit/debit card to said mobile telephone.

18. The method in accordance with claim 17, wherein said mobile telephone includes an input device, further including the steps of:
inputting a transaction amount from the input device into the memory of said mobile telephone;
wirelessly transmitting said transaction amount and said information included in the memory of the credit/debit card to a central facility to determine whether a transaction has been approved or denied;
receiving in said mobile telephone a decision as to the approval or denial of said transaction;
wirelessly transmitting from said mobile telephone to said printer the approval of said transaction; and
printing a sales slip from said printing of said transaction.

19. The method in accordance with claim 14, wherein said address is a Bluetooth address including the steps of:
providing said Bluetooth address on said smart card/tag;
opening said software application; and
putting said smart card/tag in proximity with the first device subsequent to said placing step to initiate wireless communication between the first device and the second device.

20. The method in accordance with claim 16, wherein said address is a Bluetooth address including the steps of:
providing said Bluetooth address on said smart card/tag;
opening said software application; and
putting said smart card/tag in proximity with the first device subsequent to said placing step to initiate wireless communication between the first device and the second device.
